(19) United States
(12) Patent Application Publication
(10) Pub. No.: US 2005/0014037 A1
(43) Pub. Date: Jan. 20, 2005

(54) Fuel cell with recombination catalyst

(76) Inventors: Chris Boyer, Houston, TX (US); Charles Greenwald, Bryan, TX (US); Oliver Murphy, Bryan, TX (US); Craig Andrews, College Station, TX (US); Carlos Salinas, Bryan, TX (US)

Correspondence Address: STREETS & STEELE, 13831 NORTHWEST FREEWAY, SUITE 355, HOUSTON, TX, 77040, US

(21) Appl. No.: 10/727,813

(22) Filed: Dec. 4, 2003

Related U.S. Application Data
(60) Provisional application No. 60/431,046, filed on Dec. 4, 2002.

(51) Int. Cl. H01M 8/02; H01M 8/04; H01M 8/10

(52) U.S. Cl. 429/12; 429/30; 429/38

(57) ABSTRACT

A hydrogen-oxygen fuel cell operates with greater safety if a leak develops between the anode and the cathode sides of the fuel cell allowing hydrogen and oxygen to become mixed on whichever side operates at the lower pressure. A recombination catalyst is disposed within the fuel cell to catalyze the recombination reaction of hydrogen and oxygen to form water and prevent the formation of an explosive mixture. The hydrogen-oxygen recombination catalyst is disposed in a hydrogen distribution system, an oxygen distribution system, or a combination thereof. Suitable recombination catalysts include platinum or alloys thereof, palladium, gold, tin, and combinations thereof, with or without platinum. Still other suitable recombination catalysts include, for example, noble metals, nickel-paladium, and nickel oxides. The recombination catalyst may be mixed with a bonding agent, such as polytetrafluoroethylene, so that the recombination catalyst will adhere to surfaces within the hydrogen and oxygen distribution systems.

This application claims priority to U.S. Provisional Patent Application No. 60/431,046 filed on Dec. 4, 2002.

### BACKGROUND OF THE INVENTION

1. Field of the Invention

This invention relates to fuel cells and, more particularly, preventing the accumulation of explosive mixtures of gases within fuel cells.

2. Description of the Related Art

A fuel cell is a device that converts the energy of a chemical reaction into electricity. A fuel cell can have large amounts of fuel and oxidant stored external to the cell, so that a fuel cell can generate power as long as fuel and oxidant are available within the fuel cell. Fuel cells produce an electromotive force by bringing the fuel and oxidant into contact with two suitable electrodes separated by an electrolyte.

A fuel, such as hydrogen gas, is provided at one electrode where it dissociates on the electrocatalytic surface of the positive electrode (anode) to form protons and electrons, as shown in equation 1. The electrons pass into the conductive structure of the electrode, and then to the external electrical circuit energized by the fuel cell. The protons formed by the dissociation of the hydrogen at the first electrode pass through the electrolyte to the second electrode. Simultaneously, an oxidant, such as oxygen gas or air, is introduced to the second electrode where it is adsorbed onto the electrocatalytic surface of the negative electrode (cathode). There the oxidant is electrochemically reduced by the electrons that traversed the external electrical circuit to form a surface oxide species. This surface oxide reacts with protons passing through the electrolyte to form water, the product of the net reaction. The water desorbs from the electrode and leaves the cell in the cathode gas stream. The half-cell reactions for a hydrogen consuming fuel cell at the two electrodes are, respectively, as follows:
H₂→2H⁺+2e⁻ (1)
½O₂+2H⁺+2e⁻→H₂O (2)

Connecting the two electrodes through an external circuit causes an electrical current to flow through the circuit from which electrical power may be drawn from the cell. The overall fuel cell reaction, which is the sum of the separate half-cell reactions written above, produces electrical energy and heat.

In practice, fuel cells are not operated as single units but are connected in a series to additively combine the individual cell potentials and achieve a greater, and more useful potential. The cells in a given series can be connected directly, with opposing faces of a single component in contact with the anode of one cell and the cathode of an adjacent cell, or through an external electrical linkage. A series of fuel cells, referred to as a fuel cell stack, are normally equipped with a manifold system for the distribution of the two fluids. The fuel and oxidant are directed with manifolds to the correct electrodes, and cooling is provided either by the reactants or by a cooling medium, such as through a fluid cooled bipolar plate. Also within the stack are current collectors, cell-to-cell seals, and other components. The stack and associated hardware make up the fuel cell module.

Some fuel cells have a solid polymer electrolyte, which is typically a proton exchange membrane. The membrane acts as the electrolyte as well as a barrier for preventing the mixing of the reactant gases. A PEM fuel cell is described in greater detail in Dhar, U.S. Pat. No. 5,242,764, which is fully incorporated herein by reference.

FIG. 1 is a drawing illustrating a fuel cell stack based on a conventional bipolar filter press design 10 with graphite structure elements. A full description of filter press type fuel cells may be found in Neidrach, U.S. Pat. No. 3,134,697, which is fully incorporated herein by reference. While improvements in filter press style fuel cells have provided significant increases in power per unit volume, the overall systems that have evolved are large, heavy, and relatively complex, with compressors to supply oxygen or air and pumps to provide forced water cooling systems to remove excess heat.

FIG. 2 shows the structure of a standard fuel cell membrane and electrode assembly (MEA) 20 intended for use in the bipolar stack 10 of FIG. 1, which has current collection over most of the back of the electrode. The MEA consists of a membrane 22, a catalyst layer 24, a gas diffusion layer 26 and a conductive cloth backing 28. As illustrated, a complete MEA includes similar layers formed on both sides of the membrane.

It is important to prevent leaks between the anode and cathode sides of the fuel cell because, for example, in a hydrogen/oxygen fuel cell, the hydrogen and oxygen will mix, possibly creating an explosive mixture. One method for detecting leaks as found by Fanciullo in U.S. Pat. No. 5,235,846, is a fuel cell leakage sensor that monitors for carbon dioxide concentration in the oxidant stream. A change in the carbon dioxide concentration indicates there is a leak.

Therefore, there is a need for a fuel cell that would prevent explosions or fires should a leak develop between the anode and cathode sides of the fuel cell.

### BRIEF DESCRIPTION OF THE DRAWINGS

FIG. 1 is a perspective view of a fuel cell stack based on a conventional bipolar filter press design.

FIG. 2 is a cross sectional view of the structure of a fuel cell membrane and electrode assembly.

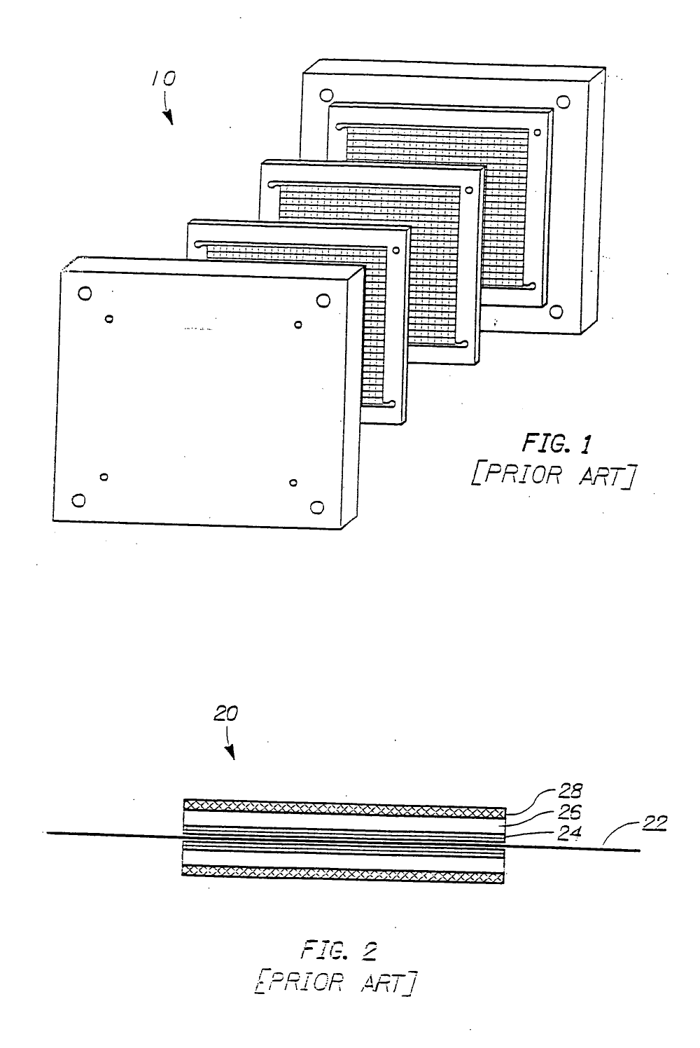

### DETAILED DESCRIPTION

The present invention provides a hydrogen-oxygen fuel cell that operates with an increased degree of safety when a leak develops between the anode and the cathode sides of the fuel cell. When a leak develops between the anode and cathode sides of a fuel cell, hydrogen and oxygen become mixed on whichever side operates at the lower pressure. If the leak is large enough, an explosive or flammable mixture may result. By disposing within the fuel cell a recombination catalyst that catalyzes the recombination reaction of hydrogen and oxygen to form water, an explosive mixture is unable to form because the recombination prevents a build up of the mixture to an explosive or other dangerous concentration.

The fuel cell of the present invention provides an ionically conducting media between an anode and a cathode. The ionically conducting media is preferably a proton conducting membrane, such as a perfluorosulfonic acid polymer. The fuel cell further comprises a hydrogen distribution system that is in fluid communication with the anode and an oxygen distribution system that is in fluid communication with the cathode. The hydrogen-oxygen recombination catalyst is disposed in the hydrogen distribution system, in the oxygen distribution system, or in a combination thereof.

The recombination catalyst is preferably platinum or alloys thereof. Other suitable catalysts include, for example, palladium, gold, tin, and combinations thereof, with or without platinum. Still other suitable recombination catalysts include, for example, noble metals, nickel-paladium, and nickel oxides.

With the recombination catalyst disposed within the fuel cell or the balance of plant, whenever a hydrogen molecule meets an oxygen molecule in the presence of the catalyst, a water molecule will be formed, thereby preventing oxygen and hydrogen from reaching an explosive mixture.

The recombination catalyst may be mixed with a bonding agent so that the recombination catalyst will adhere to surfaces within the hydrogen and oxygen distribution systems as desired. The preferred bonding agent is polytetrafluoroethylene (PTFE). The bonding agent and recombination catalyst may be applied to the desired surfaces of the fuel cell by spraying the mixture onto the surfaces, spreading the mixture onto the surfaces, dipping or rolling the surfaces into the mixture, or combinations thereof.

It is important to ensure that the bonding of the recombination catalyst onto surfaces within the fuel cell does not interfere with the electrical communication necessary for the fuel cell to operate efficiently. Therefore, it may be beneficial to create metal-to-metal bonds between various components of the fuel cell before the recombination catalyst is applied to those surfaces. The metal-to-metal bonds may be created by methods selected from welding, brazing, soldering and combinations thereof. With the creation of the metal-to-metal bonds before the application of the recombination catalyst, the electrical communication between the components bonded together is assured and the bonding of the recombination catalyst onto the exposed surfaces will not reduce the electrical communication. For example, bonding a metal flow field with a metal-to-metal bond to a bipolar plate will assure electrical communication as required between the bipolar plate and the flow field even after the recombination catalyst is bonded to the exposed surfaces of the flow field and the bipolar plate.

Alternatively, if the components to be bonded are not both metal, the bonds may be formed using adhesives before the recombination catalyst is bonded to the surfaces of the components. For example, a flow field may be made of a conductive polymer and bonded to a metal bipolar plate using a conductive adhesive, thereby assuring good electrical communication between the bipolar plate and the flow field even after the recombination catalyst is applied to the surfaces.

If the components are not bonded with a metal-to-metal bond or with a conductive adhesive, then the surface must be polished or otherwise surface treated to remove the recombination catalyst from a surface that must be in electrical communication with another component of the fuel cell. For example, for a metal flow field to be in electrical communication with an electrode, if the surface of the flow field has had a recombination catalyst applied to the surface, then it must be polished or otherwise surface treated to remove the recombination catalyst from the contact surfaces of the flow field. If the recombination catalyst is not removed from the contact surfaces, then the required electrical communication with the electrode will be reduced.

Methods of bonding electrochemical cell components with metal-to-metal bonds or with adhesive bonds is fully disclosed in U.S. patent application Ser. No. 09/237,428, which is hereby fully incorporated by reference.

The recombination catalyst may be disposed on the surface of one or more components selected from a flowfield, a gas diffusion layer, a current collector, a manifold, a frame, a bipolar plate, a monopolar plate, an endplate and combinations thereof. Each of these components may be found in both the oxygen distribution system and the hydrogen distribution system, depending on the particular design and application of the fuel cell.

A preferred surface upon which to dispose the recombination catalyst is a flow field within the oxygen distribution system, the hydrogen distribution system, or both. One embodiment of a flow field is bonded with a metal-to-metal bond or with a conductive adhesive bond to a bipolar plate. The flow field may be made of material selected from expanded metal mesh, metal foam, conducting polymer foam, porous conductive carbon and combinations thereof.

The recombination catalyst may be disposed onto surfaces of the oxygen and hydrogen distribution systems of a fuel cell having a single cell or for a fuel cell stack comprising a plurality of single fuel cells connected electrically in senes. The fuel cell stack may be a bipolar arrangement or a monopolar arrangement. Furthermore, the oxygen may be distributed to the fuel cell as a pure or nearly pure oxygen stream or as an air stream. The fuel cell or fuel cell stack may operate the hydrogen and oxygen distribution systems at pressures equal to or less than atmospheric, greater than atmospheric, or at significant differential pressures.

It will be understood from the foregoing description that various modifications and changes may be made in the preferred embodiment of the present invention without departing from its true spirit. It is intended that this description is for purposes of illustration only and should not be construed in a limiting sense. The scope of this invention should be limited only by the language of the following claims.

1. A hydrogen-oxygen fuel cell, comprising:
an ionically conducting media disposed between an anode and a cathode;
a hydrogen distribution system in communication with the anode;
an oxygen distribution system in communication with the cathode; and
a hydrogen-oxygen recombination catalyst disposed in the hydrogen distribution system, the oxygen distribution system, or a combination thereof.

2. The fuel cell of claim 1, wherein the ionically conducting media is a proton exchange membrane.

3. The fuel cell of claim 1, wherein the ionically conducting media is a perfluoronated sulphonic acid polymer.

4. The fuel cell of claim 1, wherein the recombination catalyst comprises components selected from platinum, palladium, gold, tin, and combinations thereof.

5. The fuel cell of claim 1, wherein the recombination catalyst comprises platinum.

6. The fuel cell of claim 1, wherein the recombination catalyst is mixed with a compound that bonds the recombination catalyst to one or more surfaces of the hydrogen distribution system, one or more surfaces of the oxygen distribution system, or a combination thereof.

7. The fuel cell of claim 1, wherein the recombination catalyst is disposed on a surface within the hydrogen distribution system.

8. The fuel cell of claim 7, wherein the surface is of components selected from a flowfield, a gas diffusion layer, a current collector, a manifold, a frame, a bipolar plate, a monopolar plate, an endplate and combinations thereof.

9. The fuel cell of claim 8, wherein the recombination catalyst does not reduce electrical communication of the components.

10. The fuel cell of claim 7, wherein the recombination catalyst is disposed by mixing the recombination catalyst with a bonding agent and applying the mixture to the surface, and wherein the bonding agent bonds the recombination catalyst to the surface.

11. The fuel cell of claim 10, wherein the mixture is applied by a method selected from spreading, spraying, dipping, rolling and combinations thereof.

12. The fuel cell of claim 8, wherein the flow field is made of material selected from expanded metal mesh, metal foam, conducting polymer foam, porous conductive carbon material and combinations thereof.

13. The fuel cell of claim 12, wherein the flow field is bonded by a metal-to-metal bond with the bipolar plate, the monopolar plate, the endplate or the current collector.

14. The fuel cell of claim 13, wherein the metal-to-metal bond is by a method selected from brazing, welding, soldering and combinations thereof.

15. The fuel cell of claim 13, wherein the metal-to-metal bond is formed before the recombination catalyst is disposed on the surface.

16. The fuel cell of claim 12, wherein the flow field is bonded by a conductive adhesive bond with the bipolar plate, the monopolar plate, the endplate or the current collector.

17. The fuel cell of claim 16, wherein the conductive adhesive bond is formed before the recombination catalyst is disposed on the surface.

18. The fuel cell of claim 1, wherein the recombination catalyst is disposed on a surface within the oxygen distribution system.

19. The fuel cell of claim 18, wherein the surface is of components selected from a flowfield, a gas diffusion layer, a current collector, a manifold, a frame, a bipolar plate, a monopolar plate, an endplate and combinations thereof.

20. The fuel cell of claim 19, wherein disposing the recombination catalyst does not reduce electrical communication of the components.

21. The fuel cell of claim 18, wherein the recombination catalyst is disposed by mixing the recombination catalyst with a bonding agent and applying the mixture to the surface, wherein the bonding agent bonds the recombination catalyst to the surface.

22. The fuel cell of claim 21, wherein the mixture is applied by a method selected from spreading, spraying, dipping, rolling and combinations thereof.

23. The fuel cell of claim 19, wherein the flow field is made of material selected from expanded metal mesh, metal foam, conducting polymer foam, porous conductive carbon material and combinations thereof.

24. The fuel cell of claim 23, wherein the flow field is bonded by a metal-to-metal bond with the bipolar plate, the monopolar plate, the endplate or the current collector.

25. The fuel cell of claim 24, wherein the metal-to-metal bond is by a method selected from brazing, welding, soldering and combinations thereof.

26. The fuel cell of claim 24, wherein the metal-to-metal bond is formed before the recombination catalyst is disposed on the surface.

27. The fuel cell of claim 23, wherein the flow field is bonded by a conductive adhesive bond with the bipolar plate, the monopolar plate, the endplate or the current collector.

28. The fuel cell of claim 27, wherein the conductive adhesive bond is formed before the recombination catalyst is disposed on the surface

29. The fuel cell of claim 1, wherein the oxygen distribution system is an air distribution system.

30. The fuel cell of claim 1, wherein the hydrogen and oxygen distribution systems operate at pressures less than one atmosphere.

31. The fuel cell of claim 1, wherein the hydrogen and oxygen distribution systems are operated at pressures greater than one atmosphere.

32. The fuel cell of claim 1, wherein the hydrogen and oxygen distribution systems are operated at different pressures.

33. In a hydrogen-oxygen fuel cell having an anodic electrocatalyst, a cathodic electrocatalyst, an ionically conducting membrane disposed between the anodic electrocatalyst and the cathodic electrocatalyst, anode flow field for distributing hydrogen to the anodic electrocatalyst, and a cathode flow field for distributing oxygen to the cathodic electrocatalyst, the improvement comprising:
a hydrogen-oxygen recombination catalyst disposed on one or more of the flow fields.

34. The fuel cell of claim 33, wherein the recombination catalyst comprises components selected from platinum, palladium, gold, tin, and combinations thereof.

35. The fuel cell of claim 33, wherein the recombination catalyst comprises platinum.

36. The fuel cell of claim 33 wherein the recombination catalyst is mixed with a bonding compound that bonds the recombination catalyst to the one or more flow fields.

37. The fuel cell of claim 33, wherein the recombination catalyst mixed with a bonding component does not reduce electrical communication between the one or more flow fields and the electrocatalysts.

38. The fuel cell of claim 33, wherein the one or more flow fields are made of material selected from expanded metal mesh, metal foam, conducting polymer foam, porous conductive carbon material and combinations thereof.

39. The fuel cell of claim 38, further comprising:
an anode endplate in electrical communication with the anode flow field;
a cathode endplate in electrical communication with the cathode flowfield.

40. The fuel cell of claim 39, wherein the electrical communication is through metal-to-metal bonding or through conductive adhesive bonds, and wherein the bonding is by methods selected from brazing, soldering, welding and conductive adhesives.

41. The fuel cell of claim 40, wherein the bond is formed before the recombination catalyst is bonded to one or more of the endplates.

42. The fuel cell of claim 41, wherein the recombination catalyst is bonded to one or more of the endplates with PTFE.

43. A hydrogen-oxygen fuel cell, comprising:
an ionically conducting membrane disposed between an anodic electrocatalyst and a cathodic electrocatalyst;
an anode chamber adjacent the anodic electrocatalyst for distributing hydrogen to the anodic electrocatalyst;
a cathode chamber adjacent the cathodic electrocatalyst for distributing oxygen to the cathodic electrocatalyst; and
a hydrogen-oxygen recombination catalyst disposed in one or more of the chambers.

44. The fuel cell of claim 43, wherein the recombination catalyst comprises components selected from platinum, palladium, gold, tin and combinations thereof.

45. The fuel cell of claim 43, wherein the recombination catalyst comprises platinum.

46. The fuel cell of claim 43, wherein the recombination catalyst is mixed with a bonding compound that bonds the recombination catalyst to a surface in the one or more chambers.

47. The fuel cell of claim 43, further comprising an anode flow field disposed in the anode chamber, wherein the recombination catalyst is disposed on the anode flow field.

48. The fuel cell of claim 47, wherein the recombination catalyst is mixed with a bonding compound that bonds the recombination catalyst to a surface in the anode flow field.

49. The fuel cell of claim 47, wherein the anode flow field is made of material selected from expanded metal mesh, metal foam, conducting polymer foam, porous conductive carbon material and combinations thereof.

50. The fuel cell of claim 49, further comprising a bipolar separator plate forming a wall of the anode chamber, wherein the recombination catalyst is disposed on the bipolar separator plate.

51. The fuel cell of claim 50, wherein the anode flow field is bonded to the bipolar separator plate by a method selected from brazing, soldering, welding and conductive adhesives.

52. The fuel cell of claim 51, wherein the recombination catalyst mixed with a bonding compound does not reduce electrical communication between the bipolar plate and the anode flow field.

53. The fuel cell of claim 51, wherein the recombination catalyst mixed with a bonding compound does not reduce electrical communication between the anodic electrocatalyst and the anode flow field

54. The fuel cell of claim 43, further comprising a cathode flow field disposed in the cathode chamber, wherein the recombination catalyst is disposed on the cathode flow field.

55. The fuel cell of claim 54, wherein the recombination catalyst is mixed with a bonding compound that bonds the recombination catalyst to a surface in the cathode flow field.

56. The fuel cell of claim 54, wherein the cathode flow field is made of material selected from expanded metal mesh, metal foam, conducting polymer foam, porous conductive carbon material and combinations thereof.

57. The fuel cell of claim 56, further comprising a bipolar separator plate forming a wall of the cathode chamber, wherein the recombination catalyst is disposed on the bipolar separator plate.

58. The fuel cell of claim 57, wherein the cathode flow field is bonded to the bipolar separator plate by a method selected from brazing, soldering, welding and conductive adhesives.

59. The fuel cell of claim 58, wherein the recombination catalyst mixed with a bonding compound does not reduce electrical communication between the bipolar plate and the cathode flow field.

60. The fuel cell of claim 58, wherein the recombination catalyst mixed with a bonding compound does not reduce electrical communication between the cathodic electrocatalyst and the cathode flow field

61. The fuel cell of claim 43, further comprising a gas diffusion electrode disposed in the anode chamber, wherein the recombination catalyst is disposed on the gas diffusion electrode.

62. The fuel cell of claim 61, further comprising a bipolar plate, wherein the recombination catalyst does not reduce electrical communication between the anodic electrocatalyst and the bipolar plate.

63. The fuel cell of claim 43, further comprising a gas diffusion electrode disposed in the cathode chamber, wherein the recombination catalyst is disposed on the gas diffusion electrode.

64. The fuel cell of claim 63, further comprising a bipolar plate, wherein the recombination catalyst does not reduce electrical communication between the cathodic electrocatalyst and the bipolar plate

65. The fuel cell of claim 43, further comprising:
anode fluid manifolds selected from an inlet anode fluid manifold, an outlet anode fluid manifold and combinations thereof, wherein the anode chamber manifolds are in fluid communication with the anode chamber.

66. The fuel cell of claim 65, wherein the recombination catalyst is disposed on an interior surface of one or more of the anode fluid manifolds.

67. The fuel cell of claim 43, further comprising;
cathode fluid manifolds selected from an inlet cathode fluid manifold, an outlet cathode fluid manifold and combinations thereof, wherein the cathode fluid manifolds are in fluid communication with the cathode chamber.

68. The fuel cell of claim 67, wherein the recombination catalyst is disposed on an interior surface of one or more of the cathode fluid manifolds.
